(19) United States
(12) Patent Application Publication
(10) Pub. No.: US 2025/0291694 A1
(43) Pub. Date: Sep. 18, 2025

(54) Defect Detection based on Natural Language Processing

(71) Applicant: ServiceNow, Inc., Santa Clara, CA (US)

(72) Inventors: Kiran Mushnuri, Hyderabad (IN); Anita Manda, Hyderabad (IN); Vinay Singh Ram Singh, Hyderabad (IN)

(21) Appl. No.: 18/606,331

(22) Filed: Mar. 15, 2024

(51) Int. Cl. G06F 11/34; G06F 40/30

(52) U.S. Cl. CPC G06F 11/3409; G06F 40/30

(57) ABSTRACT

An example implementation may involve: receiving a textual input indicating a performance objective, wherein the performance objective is associated with a computing platform; obtaining a semantic value associated with the performance objective; mapping the semantic value to a first performance metric, wherein the first performance metric characterizes the computing platform; obtaining performance data based on the first performance metric; and assessing the performance data to determine an evaluation of the performance objective.

### BACKGROUND

A key performance indicator (KPI) is a measurable criterion for determining performance of an application. KPIs can be used to track/monitor performance of a system. In turn, inaccurate or improperly utilized KPIs can lead to performance degradation in these systems. Selecting KPIs and using them to detect deficiencies in computing system performance poses several challenges. For example, it is difficult to translate high-level objectives (e.g., a textual description of acceptable performance) into specific quantitative metrics and numerical data, such as measurements of processor, memory, and/or network utilization. The challenges associated with translation can lead to additional challenges in identifying relevant KPIs and/or selecting the appropriate data for measuring these KPIs. Another example of a challenge in efficient use of KPIs revolves around accurate and precise data collection. The relevance, accuracy, and integrity of data used in conjunction with KPIs plays a significant role in measuring computing system performance. Thus, unreliable data and/or measurement of the wrong KPIs can result in unrecognized or unmeasured performance degradation.

### SUMMARY

Various implementations disclosed herein include systems and methods for detecting defects in computing systems by using natural language processing (NLP) to identify KPIs from a user input and determine appropriate metrics for measuring the identified KPIs. Specifically, input such as a plain language prompt received from a user is analyzed with an NLP model. The NLP model may identify one or more KPIs based on the semantic intent of the prompt. Next, the system, based on the identified KPIs, may determine metrics associated with the KPIs and/or monitoring systems for those metrics. The system may then evaluate the KPIs based on the performance data from the monitoring system. In some implementations, evaluating the KPIs involves using machine learning on historical and/or projected performance data.

These systems and methods facilitate the mapping of performance objectives for a computing system into specific and quantifiable metrics of that computing system. This mapping helps enable rapid and accurate identification of relevant KPIs as well as the corresponding data to use for measuring the relevant KPIs. By improving the selection of KPIs (and the integrity of associated data), the systems and methods disclosed herein provide better measurements of computing system performance, improved threat and defect detection, and serve to prevent degradation in system performance.

Accordingly, a first example embodiment may involve receiving a textual input indicating a performance objective associated with a computing platform, and obtaining a semantic value associated with the performance objective. The semantic value may be mapped to a first performance metric, where the first performance metric characterizes the computing platform. Performance data based on the first performance metric may be obtained and assessed to determine an evaluation of the performance objective.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a system architecture, in accordance with example embodiments.

FIG. 7 depicts an indicator mapper, in accordance with example embodiments.

FIG. 8 depicts an NLP service, in accordance with example embodiments.

FIG. 9 depicts a system mapper, in accordance with example embodiments.

FIG. 10 depicts monitoring systems and their associated metrics, in accordance with example embodiments.

FIG. 11 depicts an indicator evaluator, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

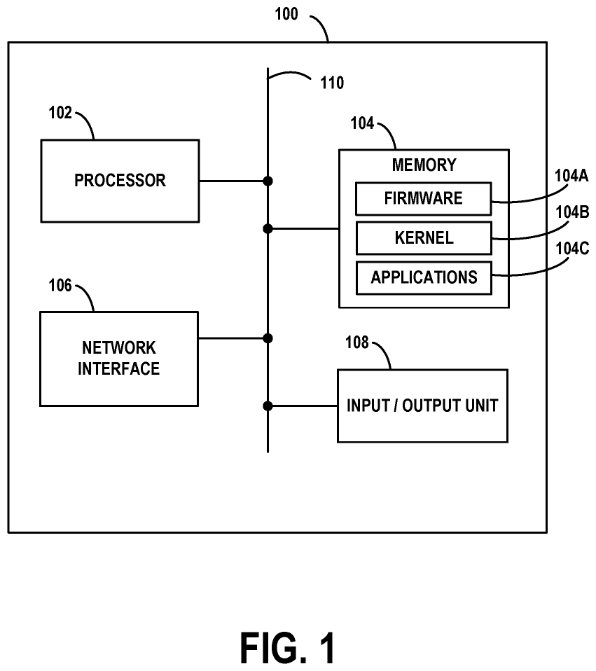

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

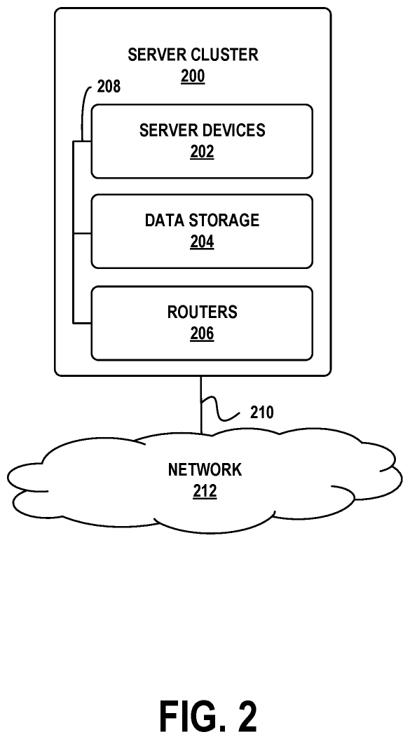

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

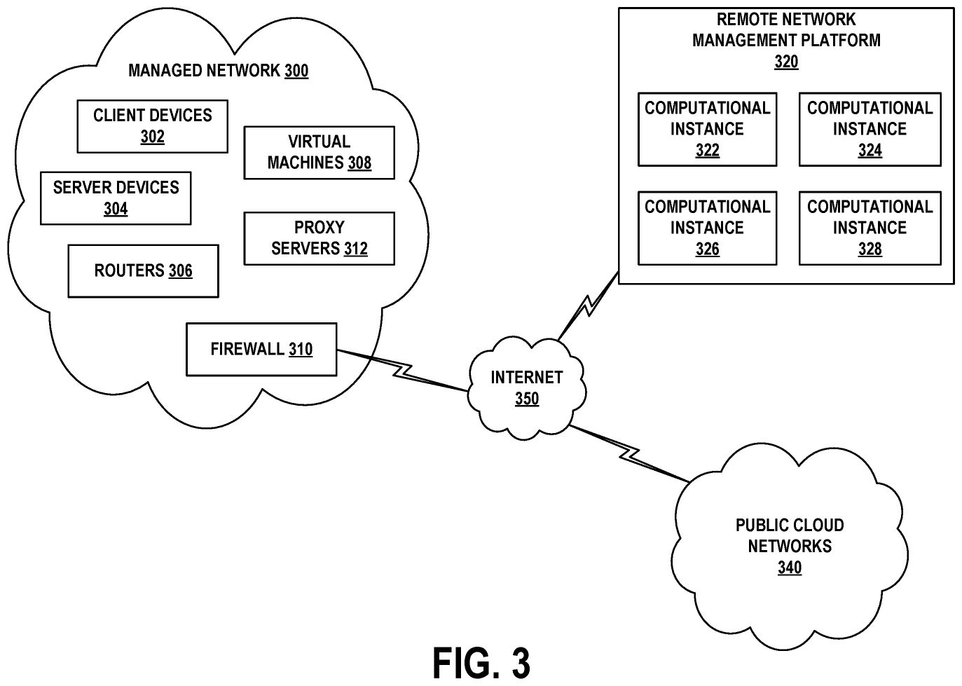

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

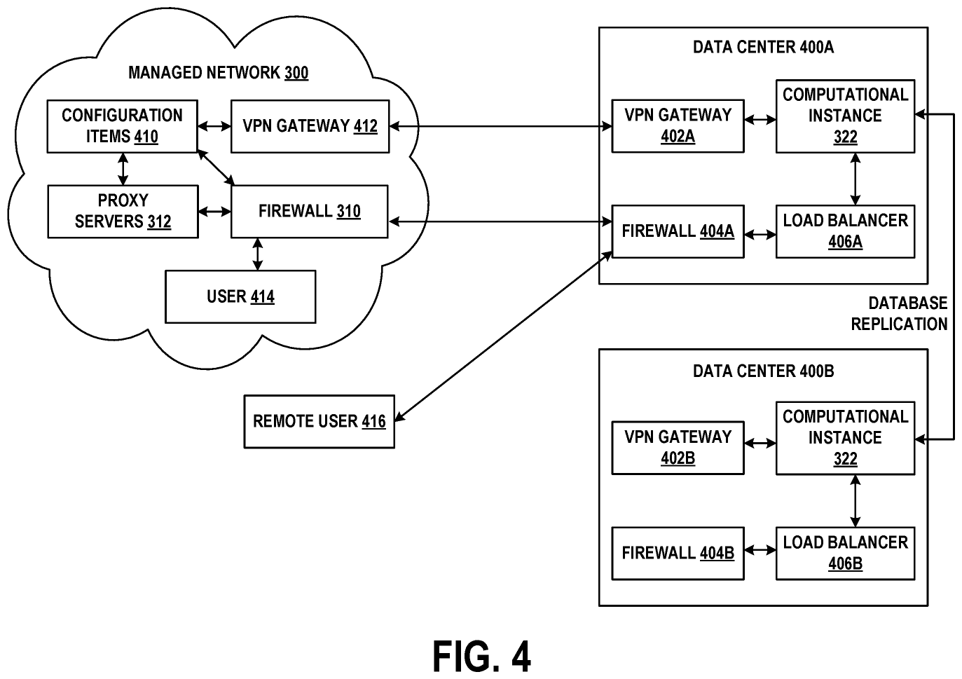

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

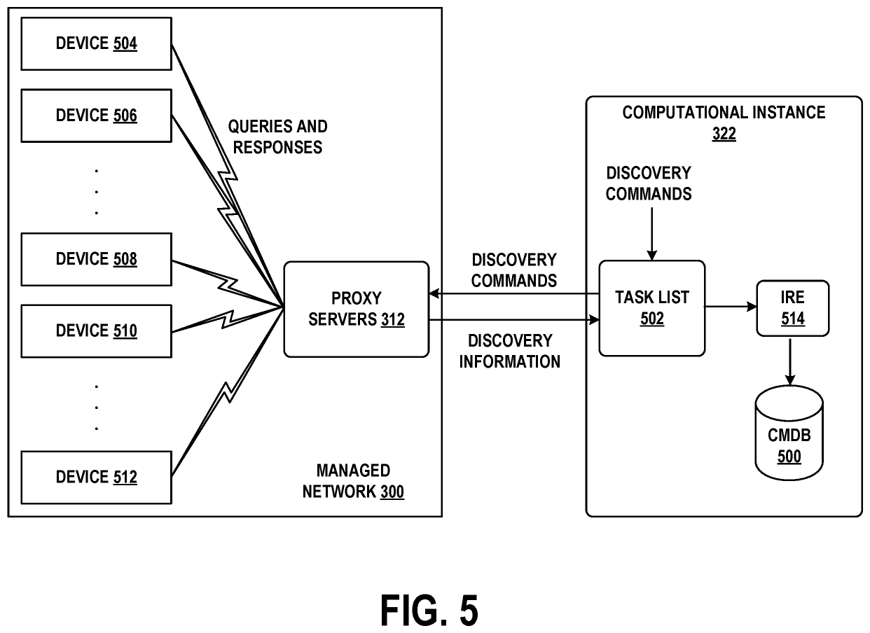

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example System Architecture

### A. KPI Overview

Key performance indicators (KPIs) are quantifiable metrics used to assess computing system performance. By accurately identifying and evaluating KPIs, system performance can be monitored, and deficiencies within a computing system can be rapidly detected. Thus, KPIs provide a focused and transparent view into the performance, reliability, usage, and robustness of a computing system.

Various types of computing systems or different components within a system can have distinct KPIs tailored to their specific functions. For instance, server and infrastructure KPIs focus on evaluating the operational efficiency and reliability of computing infrastructure. These may include CPU utilization that measures the percentage of CPU capacity utilized, memory utilization to gauge random-access memory (RAM) consumption, input/output operations to assess non-volatile storage performance, network throughput to evaluate data transfer efficiency, and power consumption to manage energy usage effectively. These KPIs may be measured for one or more tasks, for one or more applications, for a specific period of time, or they may have a different measurement scope. Some examples of deficiencies within a computing system that can be identified by monitoring or evaluating these KPIs are high CPU utilization (which may indicate resource contention or potential bottlenecks), abnormal memory usage (which may suggest memory leaks or inefficient resource allocation), and unusual power consumption (which may indicate compromised systems, unauthorized activities, or software defects).

Similarly, application performance KPIs are useful for assessing the responsiveness and reliability of software systems. These KPIs can include response time (which may indicate the duration it takes for an application to respond to user requests), error rate (which may quantify the frequency of errors or failures encountered during application execution), transaction throughput (which may measure the volume of transactions processed within a specified timeframe, reflecting the system's capacity and scalability), and availability (which may indicate the percentage of time the system remains operational and accessible to users) among other possibilities. Some examples of deficiencies within a computing system associated with these KPIs include detecting a sudden increase in error rates, which can indicate a defect, a malware infection, or a vulnerability exploitation, as well as prolonged response times, which can indicate performance issues or cyberattacks.

As another set of examples, network performance KPIs can evaluate the efficiency and reliability of network infrastructure, including packet loss (which may quantify the percentage of data packets that fail to reach their destination during transmission over the network), latency (which may measure the time it takes for a data packet to travel from its source to its destination in a network), and capacity usage (which may quantify the volume of data transmitted over a network within a timeframe). Evaluating these KPIs can help identify network anomalies and potential security threats. For instance, significant packet loss or unusually high latency may indicate network congestion, data interception, or malicious activity, prompting further investigation and threat mitigation efforts.

The selection of system KPIs is guided by the specific goals and requirements of the computing infrastructure or software system, allowing effective monitoring and improvement of system performance to meet objectives. However, selecting appropriate KPIs and utilizing them to identify deficiencies in computing system performance presents several technical challenges. Translating high-level objectives (such as a textual description of acceptable performance) into specific quantitative metrics and numerical data (e.g., measurements of processor, memory, and/or network utilization) is complex. This complexity often leads to difficulties in identifying relevant KPIs. Furthermore, even once KPIs are identified for a system, it can be difficult to determine the appropriate monitoring systems and performance data to evaluate these KPIs effectively.

### B. System Architecture

It is desirable to provide a systematic and organized framework for translating user-provided descriptions of system performance goals (prompts) into actionable evaluations of system performance, including the detection of defects and threats. Specifically, the embodiments herein include a structured approach to processing prompts to extract semantic intent and identify one or more KPIs related to the prompt's intent, determining metrics and systems associated with the KPIs, and evaluating the KPIs based on the performance data and metrics from the determined systems.

For purposes of simplicity, the terms “KPI” and “indicator” are generally used in a synonymous fashion herein. Thus, unless context suggests otherwise, these terms shall have the same meaning. Likewise, for purposes of simplicity, the terms “semantic intent” and “semantic value” are generally used in a synonymous fashion herein. Thus, unless context suggests otherwise, these terms shall have the same meaning.

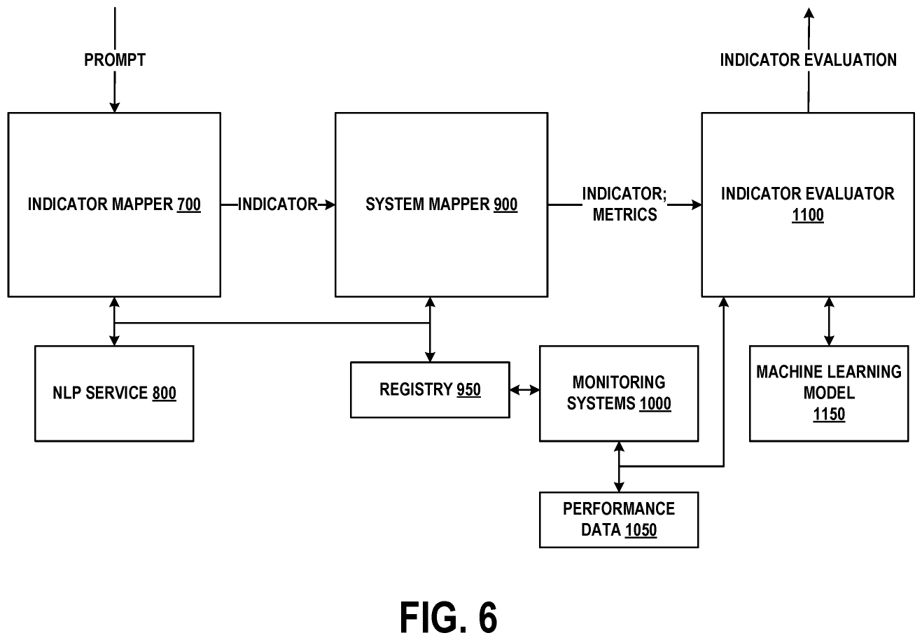

FIG. 6 depicts a possible system architecture, including indicator mapper 700, NLP service 800, system mapper 900, registry 950, monitoring systems 1000, performance data 1050, indicator evaluator 1100, and machine learning (ML) model 1150.

Initially, the system of FIG. 6 can receive a prompt, serving as an input or query, for example from a user of the system. The prompt may be textual in nature, and could describe system performance goals in technical detail or at a high level. Nonetheless, the prompt may include non-textual content, or a mix of textual and non-textual content. For instance, a user of the system could provide a prompt such as “we want our system to be available 90% of the time,” or “how much power is our system using?”

The prompt may be quantitative, meaning that input or query provided by, for example, the user, could be expressed in a numerical or measurable form and/or include numerical values and/or be measured by a numerical metric. For instance, the prompt “we want our system to be available 90% of the time,” is quantitative insofar as it provides a numerical value for a performance object, and the prompt “how much power is our system using” is quantitative insofar as it could be measured by a numerical metric, such as “500 watts.”

The prompt may also be qualitative, meaning that input or query provided by, for example, the user, could be expressed without specific numeric values or metrics. For instance, the prompt “we want our system to be fast” is qualitative insofar as it describes a performance objective without making reference to specific numerical values or a numerical measurement. The input may also be a mix of quantitative and qualitative, for instance “we want our CPU utilization to be lower than 60% and we want webpages to load quickly.” Here, the first part of the input (CPU utilization lower than 60%) is quantitative, while the second part of the input (webpages loading quickly) is qualitative.

Qualitative objectives may nevertheless be converted or modified to be quantitatively measurable and/or mapped onto KPIs with numerical metrics. For instance, an objective of having a webpage load “quickly” could be mapped onto a latency KPI, with a goal of measuring latency to be on average less than 20 ms.

Subsequently, an indicator mapper, such as indicator mapper 700, can be employed to determine a KPI based on the semantic intent of the prompt. This can be done with NLP, for example with NLP service 800. The identified KPI (indicator) can then be used by a system mapper, for example system mapper 900, to identify at least one metric associated with it, for example by querying a registry containing indicators and their associated metrics, such as registry 950. By way of registry 950, the system mapper can identify one or more systems associated with the metric (e.g., capable of measuring the metric), for example one or more monitoring systems from monitoring systems 1000. An indicator evaluator, such as indicator evaluator 1100, can then utilize performance data (metrics), for example performance data 1050, from the identified indicator and to generate an evaluation of the indicator. The evaluation process can include the use of machine learning, for example machine learning model 1150. In some examples, multiple KPIs may be identified based on the prompt.

This approach addresses challenges associated with selecting and utilizing KPIs to evaluate computing system performance. Through the use of NLP techniques, a relevant KPI can be identified based on the semantic intent of the received prompt. Once the KPI is identified, the metrics closely associated with the selected KPI can be determined, increasing the likelihood that performance measurements accurately reflect aspects of system behavior. By utilizing performance data obtained from these systems, the approach enables data-driven evaluation of KPIs, thereby improving the reliability and effectiveness of performance assessments. This enables proactive and/or reactive identification of system defects and existing or possible threats.

### VII. Example Indicator Mapping

The embodiments herein may use or rely upon various types of semantic intent extraction and methods of mapping of semantic intent from received prompts to known KPIs. This section describes some possible ways of determining semantic intent from a sample of text. Thus, any of these techniques, or other semantic intent determination techniques, can be incorporated into the embodiments herein in various arrangements. Specifically, parsing and processing text to extract semantic intent may employ NLP by way of large language models (LLMs), though other machine learning techniques may be additionally or alternatively used for NLP to extract semantic intent and identify relevant KPIs.

In the context of this disclosure, LLMs may be employed for NLP, specifically for the purposes of determining semantic intent of a received prompt to facilitate the identification of a KPI corresponding to the semantic intent of the prompt. Nevertheless, LLMs may also be used for other purposes, and other techniques may be used to determine semantic intent.

### A. Indicator Mapper

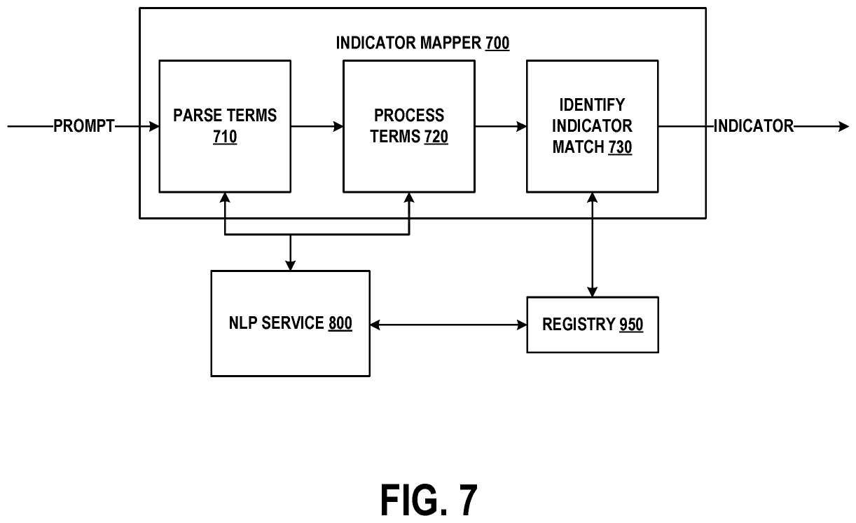

FIG. 7 depicts an example architecture for indicator mapper 700. The operations of indicator mapper 700 can take place on one or more computing devices or a computing system, for example computational instance 322 of remote network management platform 320.

The indicator mapper 700 can receive a prompt, for example from a user of the system. The prompt may be an input or query directed at a strategic objective related to the performance of a computing system. For example, a user may provide a prompt stating “we want our systems to have good CPU use.” As another example, a user could provide a prompt stating “what is the average latency in loading a webpage over the last sixth months?” Additionally or alternatively, the prompt could be received from another source, such as an upstream system or a database. Other possibilities exist.

At parse terms step 710, the indicator mapper 700 can take the received prompt and extract the words or phrases deemed relevant to KPI identification. In the context of the above example prompt reciting “what is the average latency in loading a webpage over the last six months?,” the indicator mapper 700 could identify the phrases “average latency,” “loading a webpage,” and “six months” as indicative of semantic intent of the prompt. By contrast, the phrases “what is” or “over the” could be identified as more generic and less indicative of semantic intent for the prompt.

At process terms step 720, the indicator mapper 700 can perform processing operations on terms received in the prompt. These could include procedural checks, such as correcting spelling and grammar mistakes, formatting operations, such as reordering terms or adding punctuation, or more substantive operations, such as adding or removing words or phrases. These operations may help determine the semantic intent of the prompt, or enable better matching from high-level objectives to quantifiable metrics. In the context of the example prompt “we want our systems to have good CPU use,” the operations of process terms step 720 could replace the word “good CPU use” with, for instance, “CPU utilization less than 70%” as CPU utilization below this threshold is generally understood to be more desirable than it being above this threshold. But other thresholds may be used.

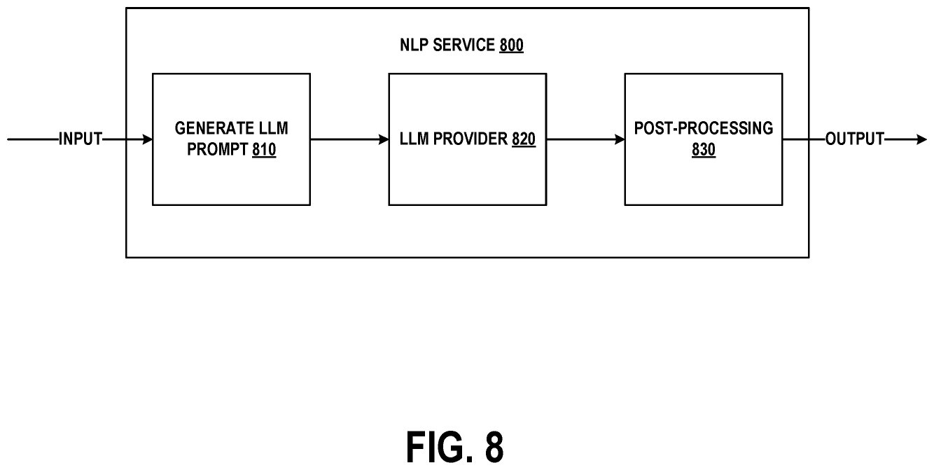

Either or both of parse terms step 710 and process terms step 720 can make use of NLP service 800, which will be described in more detail in the context of FIG. 8 below. At a high level, NLP service 800 may use machine learning techniques such as the ones discussed in the section above, to facilitate the processing and parsing of terms for identification of a KPI.

Once the prompt is received, parsed, and/or processed (including through the use of NLP service 800), at step identify indicator match 730, the indicator mapper 700 can identify one or more KPIs (indicators) associated with the prompt.

This identification of one or more KPIs could be done by way of a lookup, for example in a table of indicators that could be contained in registry 950. The NLP service 800 may have access to a list of known system KPIs, as indicated in FIG. 7 by the link between NLP service 800 and the registry 950. For instance, if the indicator mapper 700 processes the terms of the prompt at step 720 with the NLP service 800 to determine a list of indicators containing the terms “latency” and “load time,” the operations of step 730 could directly match the “latency” term to an existing system KPI for system latency.

The identification of one or more KPIs based on the semantic intent of the prompt may involve more complex classification, for example if the prompt does not contain terms that exactly match a known KPI. Additionally, the operations of identify indicator match 730 may occur in conjunction with the operations of parse terms step 710 and process terms step 720, for example by making repeating calls to the NLP service 800 to map the semantic intent of the received prompt to a KPI.

As an example of the workflow of indicator mapper 700, if the prompt provided to the indicator mapper 700 is “we want our systems to have good CPU use,” the operations of parse terms step 710 might identify “good CPU use” as a phrase containing semantic intent, and the operations of process terms step 720 could modify “good CPU use” to “CPU utilization less than 70%.” These operations may be enabled by the NLP service 800, and specifically by the LLM provider 820. Then, at identify indicator match 730, the indicator mapper could identify “CPU utilization” as the KPI for the computing system associated with the received by the indicator mapper 700.

The identified KPIs can be outputted by the indicator mapper 700. If no existing KPI can be identified, the indicator mapper 700 may find a closest-matching KPI, or may return an error message. In some examples, the system could request more information about the prompt, e.g., from the user, to facilitate identification of the KPI corresponding to the semantic intent. Other possibilities exist.

### B. NLP Service

FIG. 8 depicts an example NLP service 800 that can be used to extract semantic intent from a sample of text to facilitate the identification of KPIs corresponding to the semantic intent.

An LLM is an advanced computational model, primarily functioning within the domain of NLP and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

At generate LLM prompt step 810, the NLP service 800 may receive an input (e.g., the prompt from FIG. 7, which may have been pre-processed to, for instance, correct spelling and grammar). Based on the input, the NLP service 800 may generate a prompt for an LLM. For instance, the prompt for the LLM can be directed at using the LLM to parse or process the input and/or determine the semantic intent of the input. In the context of the example “we want our systems to have good CPU use,” the prompt for the LLM might be “what are the keywords in the text: ‘we want our systems to have good CPU use,’” which could be used to help the indicator mapper 700 parse the received text. As another example, the prompt for the LLM might be “determine the semantic intent of the statement ‘we want our systems to have good CPU use,’” or “translate “‘we want our systems to have good CPU use’ into technical and quantifiable terms,” such as “CPU utilization less than 70%.”

Additionally or alternatively, the prompt for the LLM might be directed at using the LLM to map the input text to a KPI, for instance using a prompt such as “what key performance indicators are associated with the text ‘we want our systems to have good CPU use.’” As another example in the context of the received input “what is the average latency in loading a webpage over the last six months?,” a generated prompt for the LLM could include “identify KPIs associated with the phases ‘average latency’ and ‘loading a webpage’” to enable identification of KPIs based on the text.

The prompts generated at step 810 may be pre-selected from template prompts (e.g., “what is the semantic intent of [received text]” or “what KPIs are associated with [received text]”), or they could be dynamically generated based on the inputs. In some cases, the prompt may provide the LLM with a set of KPIs to select from.

The generated prompts can be transmitted to an LLM provider 820, which may be part of NLP service 800, or located on another server (e.g., hosted by a third-party). The LLM provider 820 may be pre-trained for general text processing, and/or further fine-tuned for the specific tasks of semantic intent determination and KPI identification. The LLM provider 820 may employ architectures such as the ones discussed above, or use additional or alternative architectures and machine learning techniques. For instance, the LLM provider 820 may determine word or paragraph vectors in the LLM prompt and compare them to an existing database of word and paragraph vectors for KPIs known to the system.

Once the LLM provider 820 processes the received prompt and returns an output, the NLP service 800 may perform operations for post-processing step 830. These operations may include formatting the received output from the LLM provider 820, for instance segmenting a received paragraph of parsed terms into list form. As a concrete example, if the LLM is prompted with “identify KPIs associated with the phases ‘average latency’ and ‘loading a webpage,’” and returns the text: “the associated KPIs are ‘latency’ and ‘load time,’” the post-processing operations of 830 could reformat this output to be a list of just the terms “latency” and “load time.” After the operations of post-processing 830, if any occur, the NLP service 800 can transmit the output to the system that provided the input, for example, back to the indicator mapper 700.

### C. System Mapping

After one or more KPIs are identified based on the semantic intent of the prompt, the KPI(s) can be provided to a system mapper to automatically determine one or more metrics associated with each indicator and to determine one or more monitoring systems that measure those metrics. This facilitates rapid and accurate evaluation of the each identified KPI, providing insight into the performance of the computing system and facilitating the detection of threats or defects within the system.

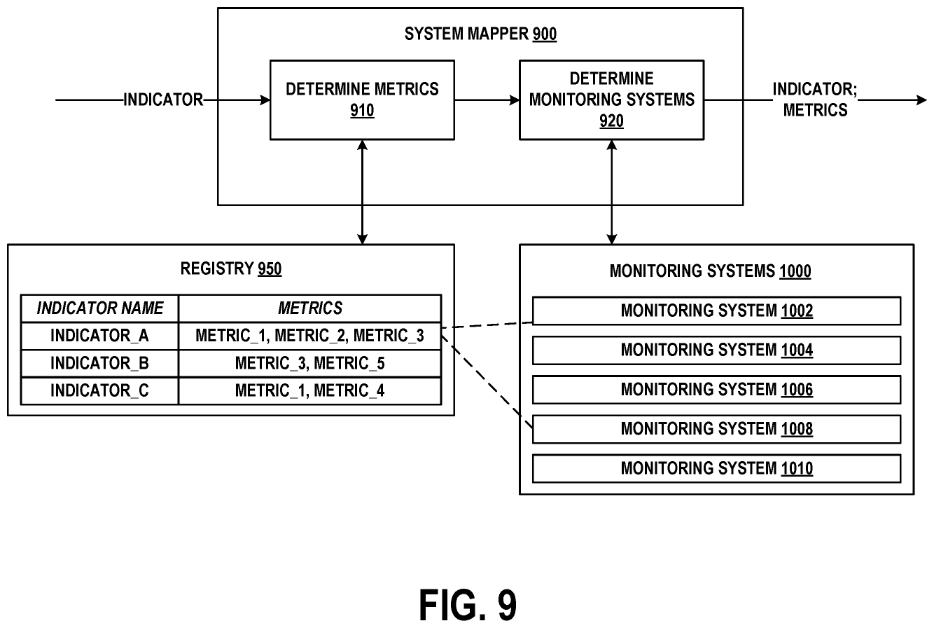

FIG. 9 depicts an example system mapper 900, which can be connected to a registry 950 of known indicators and associated metrics, as well as monitoring systems 1000 that measure the associated metrics.

1. Determining Metrics Associated with an Indicator

At determine metrics step 910 in FIG. 9, the system mapper 900 can determine one or more metrics associated with the received indicator, for example an identified KPI from the indicator mapper 700.

The operations of determine metrics step 910 may perform lookups in a registry 950 of indicators and associated metrics. For instance, “indicator_A” in registry 950 may be associated with “metric_1”, “metric_2”, and “metric_3.” Additionally or alternatively, the operations of determine metrics 910 could perform a query to other databases or logs containing metrics associated with various system indicators. The received prompt (e.g., provided by the user) could also contain information about the metrics, or the metrics may be provided to the system mapper 900 by upstream system operations and/or databases. Other possibilities exist.

In the context of the CPU utilization KPI example discussed above, the indicator “CPU utilization” could be associated with various metrics such as “CPU utilization rate” (the percentage of time the CPU is actively executing instructions, calculated as the time the CPU is busy divided by the total time), “idle time” (the percentage of time the CPU is not actively executing instructions), “interrupt time” (the percentage of time the CPU is handling hardware interrupts, which are signals sent by hardware devices to request attention from the CPU), “wait time” (the percentage of time the CPU is waiting for input/output operations to complete), and “context switches” (the number of times the CPU switches between different threads or processes in a given period of time). Many other metrics can be associated with CPU utilization.

As another example in the context of the system latency KPI, the “latency” indicator could be associated with various metrics such as “network latency” (the time it takes for a packet of data to travel from one point to another across a network), “server response time” (the time it takes for a server to process a request and send a response), “application latency” (the time it takes for an application to respond to a request), and “throughput” (the rate at which a system can process requests, e.g., measured in requests per second or transactions per second). Other possible metrics exist.

### 2. Determining Monitoring Systems for Metrics

Each of the determined metrics can be monitored by one or more monitoring systems (which could also be referred to as profiling systems). At step determine monitoring systems 920, the system mapper 900 can determine which monitoring systems measure or track the metrics associated with the identified indicator. In the context of FIG. 9, monitoring systems 1000 associated with metrics in the registry 950 include monitoring systems 1002, 1004, 1006, 1008, and 1010.

The registry 950 could contain information which monitoring systems profile each metric, for example “metric_1” could be monitored by monitoring system 1002, “metric_2” could also be monitored by monitoring system 1002, and “metric_3” could be monitored by monitoring system 1008. Thus, the system mapper 900 could identify the relevant monitoring systems by performing a lookup or query to registry 950 in order to determine the monitoring systems associated with each metric. Additionally or alternatively, the monitoring systems could be determined based on the received prompt (e.g., provided by the user), or by other upstream processes or database operations. Other possibilities for determining the monitoring systems exist.

Returning to the CPU utilization KPI example, monitoring systems associated with metrics for measuring CPU utilization (such as those discussed above) include operating system utilities (e.g., Windows Task Manager, command-line tools like Linux top, htop, and atop, macOS Activity Monitor), built-in performance monitoring tools (e.g., Perfmon in Windows, command-line tools like sar or vmstat on Unix machines) and profiling tools (e.g., DTrace, System Tap), third-party monitoring tools (e.g., New Relic or Dynatrace), or cloud service monitoring tools (e.g., Amazon CloudWatch, Google Cloud Monitoring, and Azure Monitor).

In the latency KPI example, monitoring systems associated with metrics for measuring latency (such as those discussed above) include built-in utilities (e.g., Windows Performance Monitor), system commands (e.g., Linux ping, traceroute, mtr), network tools (e.g., Chrome DevTools), third-party tools for analyzing packets (e.g., Wireshark), or cloud service monitoring tools (e.g., Amazon CloudWatch, Google Cloud Monitoring, and Azure Monitor).

Other examples of monitoring systems include ServiceNow Instance (which can provide insight into uptime and availability, security, and alerts for a system), Appsee (a mobile app analytics and qualitative mobile app analytics platform that helps app developers to understand user behavior and improve user experience), Catchpoint (a monitoring platform that provides tools for monitoring and analyzing the performance and availability of websites, APIs, mobile apps, and networks), and Splunk (a software platform designed to search, analyze, and visualize large volumes of machine-generated data in real-time).

Once the system mapper 900 determines one or more metrics associated with the received indicator and monitoring systems for those metrics, it can provide that information to an indicator evaluator, for example indicator evaluator 1100.

### D. Indicator Evaluator

The indicator evaluation uses current performance data for each metric associated with a KPI (e.g., as provided by the monitoring system for the metric) and/or records of historical performance data to compute an evaluation for the indicator. In some examples, predicted future performance data could additionally or alternatively be used to evaluate the indicator.

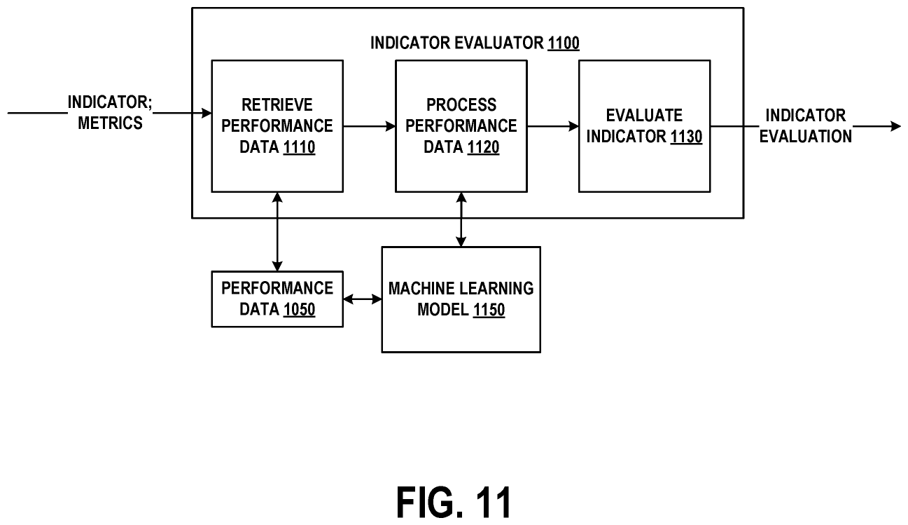

FIG. 11 provides an example indicator evaluator 1100, which can receive an indicator and/or associated metrics for the indication, as well as information about the associated monitoring systems, to generate an indicator evaluation representing the performance of the indicator (e.g., an evaluation of a KPI identified from semantic intent of a user prompt).

At retrieve performance data step 1110, the indicator evaluator 1100 can gather or retrieve performance data 1050 for metrics associated with a received indicator. The performance data 1050 may be provided by the monitoring systems of the metrics (e.g., the monitoring systems identified by system mapper 900) based on a request from the indicator evaluator 1100. Historical performance data could be stored and/or retrieved from other databases or sources, or provided by some other system. Other possibilities exist.

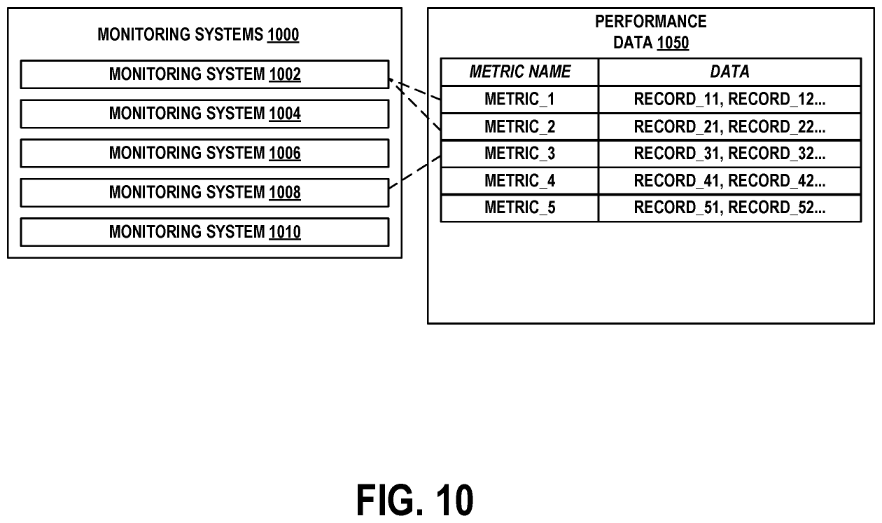

As an example, FIG. 10 illustrates monitoring systems 1000, with monitoring systems 1002, 1004, 1006, 1008, and 1010, and associated performance data 1050. Each metric may have one or more associated monitoring systems, and each monitoring system may have one or more associated metrics (i.e., a many-to-many mapping). For instance “metric_1” could be monitored by monitoring system 1002, “metric_2” could also be monitored by monitoring system 1002, and “metric_3” could be monitored by monitoring system 1008. Additionally, each metric may have associated performance data stored as records. For instance, “metric_1” has “record_11” and “record_12.”

The performance data 1050 could be stored in a variety of ways. For example, in a relational database management system (RDBMS), which are traditional databases like MySQL, PostgreSQL, or SQL Server that use tables to store data in rows and columns and are capable of storing structured data and handling complex queries. As another option, performance data 1050 could be stored in NoSQL Databases, such as MongoDB, Cassandra, or DynamoDB, which are well-suited for ideal for handling large volumes of unstructured or semi-structured data. Other options include time-series databases, distributed file systems, in-memory databases, cloud storage services, or custom-solutions.

Additionally or alternatively, performance data 1050 can be dynamically retrieved (i.e., not stored in a database) by the monitoring systems 1000, for example if the indicator evaluator 1100 makes a request for performance data. The request for performance data may specify a timeframe or quantity of performance data to be retrieved (e.g., based on user input and/or include default values).

Turning back to FIG. 11, at process performance data step 1120, the indicator evaluator 1100 can process the retrieved performance data. This could include cleaning and/or preparing the performance data, as the retrieved performance data may contain inconsistencies, errors, or missing values. For example, these steps can involve tasks such as removing duplicates, handling missing values, standardizing formats, and converting data types if necessary.

Additionally, the performance data may be transformed, for example time-series data may be aggregated into daily or monthly intervals, or categorical data may be encoded into numerical values. In the context of the CPU utilization example, the operations of process performance data step 1120 could include aggregating or averaging the CPU utilization rate data from the previous six months.

If multiple metrics are associated with a KPI, processing performance data can also include combining various metrics and/or performance data from different monitoring systems. As an example for the latency indicator, the operations of process performance data step 1120 could include summing or compiling latency data from different processes in a system (e.g., the application latency performance plus the network latency performance) to determine a measurement of total latency.

Additionally, the operations of process performance data step 1120 may leverage ML techniques, such as machine learning model 1150, to analyze the current and/or historical performance data to facilitate more complete and accurate evaluation of the metrics associated with the indicator. For example, machine learning model 1150 may perform time series analysis, a statistical technique used to examine sequential data points collected over time. Time series analysis is useful for tracking trends, patterns, and relationships within the data, and can be used to make predictions about future values.

Accordingly, machine learning model 1150 can be trained to make inferences or predictions, and machine learning models may include any one or more of the following: a decision tree (a flowchart-like tree structure where each node represents a feature, each branch represents a decision or rule, and each leaf represents an outcome) a random forest (an ensemble technique that creates multiple decision trees during training and outputs the most common classification of the individual trees), a support vector machine (finds a hyperplane that best divides a dataset into classes), a neural network (layers of interconnected nodes through which input is propagated to provide output predictions), and/or a gradient boosting machine (an ensemble technique that builds a series of weak learners—typically decision trees—in a sequential manner where each tree corrects the errors of its predecessor). Other possibilities exist.

For example, machine learning model 1150 may employ regression analysis to predict future performance based on existing performance data. Regression analysis can be used as a predictive modeling technique where the goal is to predict a continuous target variable based on one or more input features. Some examples of regression in ML are linear regression, which assumes a linear relationship between the dependent and independent variables, and nonlinear regression, which allows for more complex relationships. The model is trained using historical data and then used to make predictions on new data. Performance is evaluated based on methods such as mean squared error or R-squared, which measure the accuracy of the predictions.

As another example, machine learning model 1150 may leverage a recurrent neural network (RNN), a type of artificial neural network (ANN) designed to process sequential data by maintaining a memory of the past inputs. Unlike traditional feedforward neural networks, which process data in a strictly linear fashion, RNNs have loops within them, allowing information to persist. This makes them well-suited for tasks involving time-series data or any other kind of data that has a sequential structure. In an RNN, the output at each time step is dependent not just on the current input, but also on the previous inputs in the sequence. This allows the network to model temporal dependencies in the data. Some examples of RNNs include long short-term memory (LSTM) networks and gated recurrent unit (GRU) networks.

The use of machine learning model 1150 in the processing of performance data may provide additional insight into future threats or defects in the system that are not evident in the current performance data. For instance, in the example of CPU utilization, if the average utilization over the previous six months was 35%, an evaluation based only on historical data might conclude that the system is operating well. However, if the performance data indicates that the CPU utilization was 10% six months ago but has increased by 10% each month (i.e., 10% to 20% . . . to 60%), the use of machine learning model 1150 to predict the future performance of the CPU is likely to continue increasing and that performance of the computing system may be deleteriously impacted.

At evaluate indicator step 1130, the indicator evaluator 1100 may generate and output an evaluation of the received indicator based on the processed performance data, as well as other inputs. The indicator evaluation can take many forms depending on the indicator and systems being evaluated. For example, the indicator evaluation could include a dashboard (e.g., a visual representation including charts, graphs, and other visualizations), a scorecard (e.g., a summary of key metrics, their targets, and their current performance, as well as trends over time and comparisons to benchmarks or industry standards), a report (e.g., a more detailed analysis that could include historical data or trend analysis), or data visualization tools (e.g., using off-the-shelf tools such Tableau or Power BI to create interactive visualizations). Other possibilities exist.

The indicator evaluation can be transmitted back to a user of the system, for example, if a user provided the initial prompt to the indicator mapper 700. Returning to the CPU utilization example, the indicator evaluator 1100 may output a graph displaying average daily CPU utilization over the past six months and provide that graph to the user who inputted the prompt “we want our systems to have good CPU use.”

The indicator evaluator 1100 may also generate and output information about deficiencies associated with the indicator evaluation. For example, if the CPU is being utilized excessively by a sub-system (e.g., an email service), the indicator evaluator could generate a message alerting the user to this potential defect or deficiency. The systems and methods described herein may further receive feedback in the form of an additional prompt or input, e.g., from the user, requesting additional analysis based on the indicator evaluation. For example, the user could provide input reciting “analyze why the email service is using the CPU excessively,” and the operations according to this disclosure could be repeated.

Similarly, if multiple KPIs are detected in the original prompt provided to the system, the operations of the indicator mapper 700, system mapper 900, and indicator evaluator 1100 may be repeated. The indicator evaluation may generate multiple indicator evaluations for each KPI, or create an overall evaluation of the system, for example if there is overlap between metrics associated with each identified KPI.

In some embodiments, the indicator evaluator 1100 may also provide suggestions for how to correct a detected deficiency or degradation in performance, for example by generating a message containing a list of possible fixes to the detected deficiency (e.g., “try rebooting a server” or “try restarting the program”) and/or systems to investigate further (e.g., “CPU utilization is abnormally high, review utilization logs for more information about which applications are running”). Additionally or alternatively, the indicator evaluator 1100 may try to identify a specific program causing a defect (e.g., which application is using a large amount of CPU capacity).

The indicator evaluator 1100 may also initiate or perform a remedial action based on the evaluation of the indicator. For example, if the indicator does not meet a threshold value, the indicator evaluator 1100 could transmit a request to remedy the defect and/or directly perform operations to remedy the defect. For instance, if CPU utilization is detected to be at 99%, and one application is using 70% of the total, the indicator evaluator 1100 could transmit a request to restart that application, or perform operations to directly restart the application. Additionally or alternatively, such remedying operations could be done automatically or proactively, e.g., the indicator evaluator 1100 could be programed to measure a KPI at a specified interval and given permissions to modify applications or programs if the KPI does not meet a threshold value.

These modifications could include restarting an application as noted above, as well as other modulations such as rebooting a computing device, allocating more memory to an application or service, making more virtual server capacity available to an application or service, adjusting the distribution of tasks across computational instances or server devices (e.g., via load balancing), reindexing a database, adjusting the content of configuration files, clearing a cache, and so on. Other possibilities exist.

### VIII. Example Technical Improvements

These embodiments provide a technical solution to a technical problem. One technical problem being solved is the identification of KPIs for a computing system and an evaluation of performance based on the identified KPIs. In practice, this is problematic because users of systems may not know how their high-level objectives translate into quantifiable metrics for a computing system, much less which performance data and analysis to use to when trying to measure the KPI. As noted above, being unable to identify KPIs or misidentifying KPIs will often result in the computing system suffering from performance degradation, as critical performance metrics are not being measured or interpreted properly.

In the prior art, systems relied on users selecting a KPI from a list or database and providing parameters to use when evaluating the KPI (e.g., selecting “CPU utilization” and specifying a timeframe). However, these techniques do not enable a user who is unfamiliar with technical language and metrics to accurately select the KPI corresponding to their goals, nor a systematic approach to evaluating the KPI based on historical, current, and/or predicted performance data. Moreover, the prior art relies on subjective decisions and experiences of users of the system, which leads to wildly varying outcomes from instance to instance. Thus, prior art techniques did little if anything to address the identification of KPIs and detection of defects or performance evaluations for computing systems.

The embodiments herein overcome these limitations by using NLP to identify KPIs based on semantic intent and automatically determining appropriate metrics to measure the identified KPIs. In this manner, the detection of threats and performance evaluations for computing systems can be accomplished in a more accurate and robust fashion. This results in several advantages. First, KPIs corresponding to high-level objects are more likely to be correctly identified. For instance, if a user of a system wants “faster loading time” but is unfamiliar with the latency KPI, the systems and methods described in this disclosure may result in the identification of the latency KPI based on the analysis of semantic intent from the user's prompt. Second, once the KPI is identified based on semantic intent, metrics and monitoring systems associated with the KPI are automatically determined, enabling more rapid and accurate evaluation of the performance of the computing system, as well as identifying potential defects. Third, the evaluation of the KPI generated can provide real-time and future insight into the behavior of the computing system, helping avoid degradations in system performance.

Other technical improvements may also flow from these embodiments, and other technical problems may be solved. Thus, this statement of technical improvements is not limiting and instead constitutes examples of advantages that can be realized from the embodiments.

### IX. Example Operations

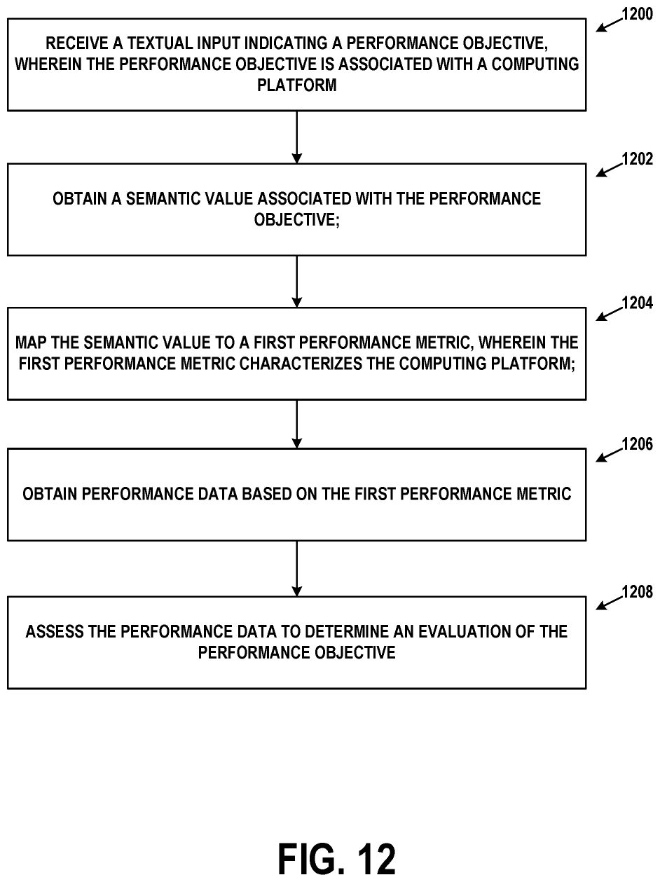

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 12 may be simplified by the removal of any one or more of the features shown therein. Further, these embodiments may be combined with features, aspects, and/or implementations of any of the previous figures or otherwise described herein.

Block 1200 may include receiving a textual input indicating a performance objective, wherein the performance objective is associated with a computing platform.

Block 1202 may include obtaining a semantic value associated with the performance objective.

Block 1204 may include mapping the semantic value to a first performance metric, wherein the first performance metric characterizes the computing platform.

Block 1206 may include obtaining performance data based on the first performance metric.

Block 1208 may include assessing the performance data to determine an evaluation of the performance objective.

In some examples, the semantic value may be obtained by analyzing the textual input with a natural language processing (NLP) model.

In some examples, the textual input may include a quantitative indication the performance objective. The semantic value may be based on the quantitative indication of the performance objective, and the semantic value may be quantitative.

In some examples, the textual input may a qualitative indication the performance objective. The semantic value may be based on the qualitative indication of the performance objective, and the semantic value may be qualitative.

In some examples, obtaining the semantic value may include determining a term from the textual input that may be indicative of the semantic value, and mapping the semantic value to the first performance metric may include matching the term from the textual input to a further term associated with the first performance metric.

In some examples, the first performance metric may be selected from a list of pre-determined performance metrics related to the computing platform.

In some examples, obtaining the performance data may include identifying a monitoring system associated with the first performance metric, determining a time period for the performance data, obtaining, from the monitoring system, the performance data over the time period, and aggregating the performance data over the time period.

In some examples, the performance data may be obtained from real-time monitoring of the computing platform. Assessing the performance data may include obtaining historical performance data, generating a comparison between the performance data and the historical performance data, assessing the comparison to further determine the evaluation of the performance objective, and outputting the evaluation of the performance objective. The evaluation of the performance objective may be based on the comparison. In some further examples, assessing the performance data may also include providing, as input to a machine learning model, the performance data and the historical performance data, receiving, from the machine learning model, a prediction of future performance data, and assessing the prediction of future performance data to further determine the evaluation of the performance objective.

Some examples may include mapping the semantic value associated with the performance objective to a second performance metric. The second performance metric may characterize the computing platform and may differ from the first performance metric. Some examples may further include obtaining additional performance data based on the second performance metric, assessing the additional performance data to further determine the evaluation of the performance objective, and outputting the evaluation of the performance objective. The evaluation of the performance objective may be based on the performance data and the additional performance data. Some further examples may include generating, based on the evaluation of the performance objective, a visual representation of the evaluation of the performance objective. The visual representation may include the evaluation of the performance objective and a graph of the performance data over a period of time. Some further examples may include transmitting the visual representation for display.

Some examples may include determining a threshold value for the performance objective and determining, based on the evaluation of the performance objective and the threshold value for the performance objective, a deficiency in the computing platform. In some further examples, the threshold value may be included in the textual input. Mapping the semantic value to the first performance metric may include mapping the threshold value to the first performance metric. Some examples may further include determining, based on the deficiency in the computing platform, a remedial action that can occur on the computing platform. The remedial action may include restarting a portion of the computing platform. Some further examples may include performing the remedial action on the computing platform.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a textual input indicating a performance objective, wherein the performance objective is associated with a computing platform;
obtaining a semantic value associated with the performance objective;
mapping the semantic value to a first performance metric, wherein the first performance metric characterizes the computing platform;
obtaining performance data based on the first performance metric; and
assessing the performance data to determine an evaluation of the performance objective.

2. The method of claim 1, wherein the semantic value is obtained by analyzing the textual input with a natural language processing (NLP) model.

3. The method of claim 1, wherein the textual input comprises a quantitative indication the performance objective, wherein the semantic value is based on the quantitative indication of the performance objective, and wherein the semantic value is quantitative.

4. The method of claim 1, wherein the textual input comprises a qualitative indication the performance objective, wherein the semantic value is based on the qualitative indication of the performance objective, and wherein the semantic value is qualitative.

5. The method of claim 1, wherein obtaining the semantic value comprises determining a term from the textual input that is indicative of the semantic value, and wherein mapping the semantic value to the first performance metric comprises matching the term from the textual input to a further term associated with the first performance metric.

6. The method of claim 1, wherein the first performance metric is selected from a list of pre-determined performance metrics related to the computing platform.

7. The method of claim 1, wherein obtaining the performance data comprises:
identifying a monitoring system associated with the first performance metric;
determining a time period for the performance data;
obtaining, from the monitoring system, the performance data over the time period; and
aggregating the performance data over the time period.

8. The method of claim 1, wherein the performance data is obtained from real-time monitoring of the computing platform, and wherein assessing the performance data comprises:
obtaining historical performance data;
generating a comparison between the performance data and the historical performance data;
assessing the comparison to further determine the evaluation of the performance objective; and
outputting the evaluation of the performance objective, wherein the evaluation of the performance objective is based on the comparison.

9. The method of claim 8, wherein assessing the performance data further comprises:
providing, as input to a machine learning model, the performance data and the historical performance data;
receiving, from the machine learning model, a prediction of future performance data; and
assessing the prediction of future performance data to further determine the evaluation of the performance objective.

10. The method of claim 1, further comprising:
mapping the semantic value associated with the performance objective to a second performance metric, wherein the second performance metric characterizes the computing platform and differs the first performance metric;
obtaining additional performance data based on the second performance metric;
assessing the additional performance data to further determine the evaluation of the performance objective; and
outputting the evaluation of the performance objective, wherein the evaluation of the performance objective is based on the performance data and the additional performance data.

11. The method of claim 1, further comprising:
generating, based on the evaluation of the performance objective, a visual representation of the evaluation of the performance objective, wherein the visual representation comprises the evaluation of the performance objective and a graph of the performance data over a period of time; and
transmitting the visual representation for display.

12. The method of claim 1, further comprising:
determining a threshold value for the performance objective; and
determining, based on the evaluation of the performance objective and the threshold value for the performance objective, a deficiency in the computing platform.

13. The method of claim 12, wherein the threshold value is included in the textual input, and wherein mapping the semantic value to the first performance metric comprises mapping the threshold value to the first performance metric.

14. The method of claim 12, further comprising:
determining, based on the deficiency in the computing platform, a remedial action that can occur on the computing platform, wherein the remedial action comprises restarting a portion of the computing platform; and
performing the remedial action on the computing platform.

15. A non-transitory computer-readable medium, having stored thereon program instructions that, upon execution by a computing system, cause the computing system to perform operations comprising:
receiving a textual input indicating a performance objective, wherein the performance objective is associated with a computing platform;
obtaining a semantic value associated with the performance objective;
mapping the semantic value to a first performance metric, wherein the first performance metric characterizes the computing platform;
obtaining performance data based on the first performance metric; and
assessing the performance data to determine an evaluation of the performance objective.

16. The non-transitory computer-readable medium of claim 15, wherein the semantic value associated with the performance objective is obtained by analyzing the textual input with a natural language processing (NLP) model.

17. The non-transitory computer-readable medium of claim 15, wherein the textual input comprises a quantitative indication the performance objective, wherein the semantic value is based on the quantitative indication of the performance objective, and wherein the semantic value is quantitative.

18. The non-transitory computer-readable medium of claim 15, wherein the textual input comprises a qualitative indication the performance objective, wherein the semantic value is based on the qualitative indication of the performance objective, and wherein the semantic value is qualitative.

19. The non-transitory computer-readable medium of claim 15, wherein obtaining the semantic value comprises determining a term from the textual input that is indicative of the semantic value, and wherein mapping the semantic value to the first performance metric comprises matching the term from the textual input to a further term associated with the first performance metric.

20. A system comprising:
one or more processors; and
memory, containing program instructions that, upon execution by the one or more processors, cause the system to perform operations comprising:
receiving a textual input indicating a performance objective, wherein the performance objective is associated with a computing platform;
obtaining a semantic value associated with the performance objective;
mapping the semantic value to a first performance metric, wherein the first performance metric characterizes the computing platform;
obtaining performance data based on the first performance metric; and
assessing the performance data to determine an evaluation of the performance objective.
